(19) United States
(12) Patent Application Publication
(10) Pub. No.: US 2024/0239329 A1
(43) Pub. Date: Jul. 18, 2024

(54) CONTROL SYSTEM FOR VEHICLE

(71) Applicant: TOYOTA JIDOSHA KABUSHIKI KAISHA, Toyota-shi (JP)

(72) Inventors: Taichi KOBAYASHI, Susono-shi (JP); Yoshio ITOU, Susono-shi (JP); Yu INASE, Susono-shi (JP)

(73) Assignee: TOYOTA JIDOSHA KABUSHIKI KAISHA, Toyota-shi (JP)

(21) Appl. No.: 18/484,482

(22) Filed: Oct. 11, 2023

(30) Foreign Application Priority Data
Jan. 13, 2023 (JP) 2023-004046

(51) Int. Cl. B60W 20/15; B60K 17/346; B60K 17/356; B60W 10/08; B60W 10/14; B60W 30/045; B60W 50/00; F16H 48/06; F16H 48/36

(52) U.S. Cl. CPC B60W 20/15; B60K 17/3462; B60K 17/356; B60W 10/08; B60W 10/14; B60W 30/045; B60W 50/0097; F16H 48/06; F16H 48/36; B60W 10/06

(57) ABSTRACT

A control system for a vehicle configured to stabilize a behavior of the vehicle by controlling a split ratio of torque distributed to front wheels and rear wheels. In the vehicle, a split ratio of the torque distributed to the front wheels and to the rear wheels through a transfer is changed by a torque of the motor.

The control system is configured to execute a drive force distribution control to control the torque of the motor to adjust the split ratio to a target ratio, and to execute a turning behavior stabilizing control instead of the drive force distribution control to temporarily increase the torque of the motor when the vehicle is understeering or oversteering.

### CROSS-REFERENCE TO RELATED APPLICATIONS

The present disclosure claims the benefit of Japanese Patent Application No. 2023-004046 filed on Jan. 13, 2023 with the Japanese Patent Office, the disclosure of which is incorporated herein by reference in its entirety.

### BACKGROUND

### Field of the Invention

Embodiments of the present disclosure relate to the art of a control system for a four-wheel drive layout vehicle in which a drive force is established by both pairs of front wheels and rear wheels.

### Discussion of the Related Art

U.S. Publication No. 2012/0077633 discloses an invention relating to four-wheel drive vehicles. The four-wheel drive vehicle described in U.S. Publication No. 2012/0077633 is a hybrid vehicle comprising a prime mover including an engine and a motor, and a hybrid drive system for four-wheel driving.

The hybrid drive system includes an engine, a motor, a transmission, a rear drive line, a front drive line, and an electric transfer. The electric transfer comprises a housing attached to the transmission, a first input shaft, a second input shaft, a planetary gear set, a rear output shaft, and a front output shaft. The first input shaft delivers the output torque of the engine via the transmission, and the second input shaft delivers the torque to the front output shaft via the chain transmission mechanism. The planetary gear set comprises a sun gear that is selectively connected to a rotor of the motor by a motor clutch, a ring gear that is connected to the first input shaft, a plurality of planetary gears, and a carrier that is connected to the front output shaft through the second input shaft and the chain transmission mechanism. The rear output shaft is connected to the rear propeller shaft, and is also connected selectively to the first input shaft and the ring gear by a first mode clutch. On the other hand, the front output shaft is connected to the front propeller shaft, and the rotation thereof is selectively restricted by the second mode clutch.

JP-A-05-278490 describes a drive force distribution device for a four-wheel drive vehicle capable of changing a distribution ratio of a drive force to a pair of front wheels and a pair of rear wheels by adjusting a transmission torque of a differential restriction clutch (an engagement force of the clutch). In the drive force distribution device of the four-wheel drive vehicle described in JP-A-05-278490, an engagement force of the clutch is obtained based on a difference between rotational speeds of the front wheels and the rear wheels.

The engagement force of the clutch is corrected by multiplying the engagement force by a correction factor determined based on a difference between a target yaw rate and an actual yaw rate. Therefore, according to the drive force distribution device of the four-wheel drive vehicle described in JP-A-05-278490, even if oversteering or understeering occurs during turning of the vehicle, the behavior of the vehicle can be corrected so as to realize the target yaw rate. As a result, a turning behavior can be stabilized.

As described above, the four-wheel drive vehicle described in U.S. Publication No. 2012/0077633 is provided with the electric transfer, and it is possible to control the distribution of the drive force to the front wheels and the rear wheels (a split ratio of the drive torque of the front output shaft and the rear output shaft) by the output torque of the motor. For example, the understeering or the oversteering can be suppressed to stabilize the behavior of the vehicle by changing the distribution of the drive force by the output torque of the motor during turning of the vehicle. In general, if a larger drive force is distributed to the front wheels, understeering tends to occur during turning. By contrast if a larger drive force is distributed to the rear wheels, oversteering tends to occur during turning. In addition, since rotational speeds of the front wheels and the rear wheels are governed by the situation in the initial phase of the turning, the speed of the front wheels and the speed of the rear wheels are not significantly different from each other. Therefore, the behavior of the vehicle is stabilized in the initial phase of the turning. Typically, if the front and rear wheels are rotating at substantially same speeds, the vehicle tends to be understeering. Whereas, if the vehicle having the aforementioned transfer for controlling the distribution of the drive force is understeering or oversteering due to a speed difference between the front wheels and the rear wheels, the speed difference between the front wheels and the rear wheels may be converged by controlling the distribution of the drive force through the transfer by the output torque of the motor. As a result, excessive understeering or oversteering can be suppressed, and the behavior of the vehicle can be stabilized.

However, for example, in a situation where the output torque of the engine is small and the motor has already generated a large torque, the output torque of the motor would be insufficient to control the distribution of the drive force through the transfer. In such situation, the speed difference between the front wheels and the rear wheels may not be immediately eliminated to suppress the understeering or the oversteering. In addition, since the speed difference between the front wheels and the rear wheels is maintained for a long time, the behavior of the vehicle would be disturbed.

### SUMMARY

Aspects of embodiments of the present disclosure have been conceived noting the foregoing technical problems, and it is therefore an object of the present disclosure to provide a control system for a vehicle configured to appropriately stabilize a behavior of the vehicle by controlling a split ratio of a torque distributed to front wheels and rear wheels through a transfer.

According to one aspect the present disclosure, there is provided a control system for a vehicle comprising: a main prime mover that generates a drive torque; a motor that generates a torque different from the drive torque; and a transfer that distributes the drive torque to front wheels and to rear wheels while changing a split ratio of the drive torque distributed to the front wheels and to the rear wheels. In the vehicle, a drive force to propel the vehicle is established by both of the front wheels and the rear wheels. Specifically, the transfer comprises: a differential mechanism in which a first rotary element, a second rotary element, and a third rotary element are rotated differentially; a front output shaft that delivers the torque to the front wheels; and a rear output shaft that delivers the torque to the rear wheels. In the differential mechanism, the first rotary element is connected to the motor in a torque transmittable manner, the second rotary element is connected to the front output shaft in a torque transmittable manner, and the third rotary element is connected to the main prime mover and the rear output shaft in a torque transmittable manner. The control system comprises a controller that controls the motor. In order to achieve the above-explained objective, according to one aspect of the present disclosure, the controller is configured to: execute a drive force distribution control to control the torque of the motor such that the split ratio of the drive torque is adjusted to a target ratio; and execute a turning behavior stabilizing control temporarily instead of the drive force distribution control to increase the torque of the motor, when understeering or oversteering greater than a reference value is determined or predicted based on a behavior and a running condition of the vehicle while the vehicle is turning.

In a non-limiting embodiment, the turning behavior stabilizing control may include: a control to increase the torque of the motor in a direction that a rotational speed of the rear output shaft is increased to a rotational speed of the front output shaft or higher, based on determination or prediction of the understeering; and a control to increase the torque of the motor in a direction that the rotational speed of the front output shaft is increased to the rotational speed of the rear output shaft or higher, based on determination or prediction of the oversteering. That is, when an occurrence of understeering is determined or predicted, the torque of the motor is increased in a direction to suppress the understeering or to cause oversteering. Whereas, when an occurrence of oversteering is determined or predicted, the torque of the motor is increased in a direction to suppress the oversteering or to cause understeering.

The controller according to the present disclosure may be configured to determine or predict the occurrence of the understeering or the oversteering based on a steering angle and a sideslip angle of a gravity center of the vehicle during turning or after the commencement of turning. For example, the controller determines the occurrence of the understeering when the sideslip angle of the gravity center is small with respect to the steering angle of the vehicle, and determines the occurrence of the oversteering when the sideslip angle of the gravity center is large with respect to the steering angle of the vehicle.

The controller according to the present disclosure may be further configured to determine or predict the occurrence of understeering or oversteering based on a speed difference between the front output shaft and the rear output shaft during turning or after the commencement of turning. For example, the controller determines the occurrence of understeering when the rotational speed of the front output shaft is higher than the rotational speed of the rear output shaft, and determines the occurrence of oversteering when the rotational speed of the rear output shaft is higher than the rotational speed of the front output shaft.

The controller according to the present disclosure may be further configured to predict the occurrence of understeering or oversteering before the vehicle starts turning, and to execute the turning behavior stabilization control when the vehicle starts turning.

According to another aspect the present disclosure, there is provided a control system for a vehicle comprising: a main prime mover that generates a drive torque; a motor that generates a torque different from the drive torque; and a transfer that distributes the drive torque to front wheels and to rear wheels while changing a split ratio of the drive torque distributed to the front wheels and to the rear wheels. In the vehicle, a drive force to propel the vehicle is established by both of the front wheels and the rear wheels. Specifically, the transfer comprises: a differential mechanism in which a first rotary element, a second rotary element, and a third rotary element are rotated differentially; a front output shaft that delivers the torque to the front wheels; and a rear output shaft that delivers the torque to the rear wheels. In the differential mechanism, the first rotary element is connected to the motor in a torque transmittable manner, the second rotary element is connected to the front output shaft in a torque transmittable manner, and the third rotary element is connected to the main prime mover and the rear output shaft in a torque transmittable manner. The control system comprises a controller that controls the motor. In order to achieve the above-explained objective, according to another aspect of the present disclosure, the controller is configured to: execute a drive force distribution control to control the torque of the motor such that the split ratio of the drive torque is adjusted to a target ratio, and execute a speed difference reduction control temporarily instead of the drive force distribution control to increase the torque of the motor, when a difference between a rotational speed of the front output shaft and a rotational speed of the rear output shaft is greater than a reference value.

In a non-limiting embodiment, the speed difference reduction control may include: a control to increase the torque of the motor in a direction that the rotational speed of the rear output shaft is increased to the rotational speed of the front output shaft or higher, when the rotational speed of the front output shaft is higher than the rotational speed of the rear output shaft; and a control to increase the torque of the motor in a direction that the rotational speed of the front output shaft is increased to the rotational speed of the rear output shaft or higher, when the rotational speed of the rear output shaft is higher than the rotational speed of the front output shaft. That is, when the rotational speed of the front output shaft is higher than the rotational speed of the rear output shaft, the torque of the motor is increased in a direction to suppress the understeering or to cause oversteering. Whereas, when the rotational speed of the rear output shaft is higher than the rotational speed of the front output shaft, the torque of the motor is increased in a direction to suppress the oversteering or to cause understeering.

The controller according to the present disclosure may be configured to change the above-mentioned reference value based on the behavior and the traveling conditions of the vehicle, and to reduce the reference value (that is, to facilitate execution of the speed difference reduction control) when the behavior or the traveling condition is determined to increase the speed difference. For example, the controller decreases the reference value as a reduction in the coefficient of friction of the road surface on which the vehicle travels. Otherwise, the controller decreases the reference value when the vehicle travels on a rough road having large irregularities.

In a non-limiting embodiment, the differential mechanism may include a planetary gear set comprising a sun gear serving as the first rotary element, a carrier serving as the second rotary element, and a ring gear serving as the third rotary element. The rear output shaft may extend coaxially with a common rotational center axis of the main prime mover and the planetary gear set, and the front output shaft may extend along an axis different from the rotational center axis of the rear output shaft.

The vehicle to which the control system according to the present disclosure is applied is a four-wheel drive vehicle in which the drive torque is distributed to front and rear wheels through the differential mechanism of the transfer. A motor is connected to the differential mechanism of the transfer, and the split ratio of the torque distributed to the front wheels and to the rear wheels may be changed by controlling the output torque (motor torque) of the motor. The control system according to the present disclosure is configured to execute the drive force distribution control to control the split ratio of the drive torque distributed to the front wheels and the rear wheels in accordance with a predetermined target split ratio by controlling the motor torque.

The control system according to the present disclosure is further configured to execute the turning behavior stabilization control to suppress excessive understeering or oversteering during turning. In the case of executing the turning behavior stabilization control, the motor torque is temporarily or instantaneously increased when an understeering or oversteering greater than the reference value is determined or predicted. In this case, the motor torque is not controlled based on the drive force distribution control, and the motor is allowed to generate a torque greater than an upper limit torque of the drive force distribution control executed in the normal condition. Therefore, in the event of the occurrence of excessive understeering or oversteering during turning of the vehicle, a large motor torque can be generated instantaneously thereby suppressing the understeering or oversteering quickly. Otherwise, if the occurrence of excessive understeering or oversteering is predicted during turning of the vehicle, a large motor torque can be generated instantaneously thereby preventing the occurrence of the understeering or oversteering in advance.

The control system according to the present disclosure is further configured to execute the speed difference reduction control when the speed difference between the front output shaft and the rear output shaft exceeds the reference value, that is, when the speed difference between the front wheels and the rear wheels is large. In the case of executing the speed difference reduction control, the motor torque is temporarily or instantaneously increased when a speed difference between the front wheels and the rear wheels exceeds the reference value or when such exceedance of the speed difference is predicted. In this case, the motor torque is not controlled based on the drive force distribution control, and the motor is allowed to generate a torque greater than the upper limit torque of the drive force distribution control executed in the normal condition. Therefore, when the behavior of the vehicle is expected to be disturbed due to increase in the speed difference between the front wheels and the rear wheels, a large motor torque can be generated instantaneously thereby reducing the speed difference rapidly. Otherwise, when the increase in the speed difference between the front wheels and the rear wheels is predicted, a large motor torque is generated instantaneously thereby reducing the speed difference rapidly.

Thus, the control system according to the present disclosure is configured to control the split ratio of the torque distributed to the front wheels and the rear wheels by the torque of the motor connected to the transfer. Therefore, the behavior of the vehicle can be appropriately stabilized.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1A is a schematic illustration showing an entire structure of the vehicle to which the control system according to the present disclosure is applied, and FIG. 1B is a skeleton diagram showing a structure of the transfer mounted in the vehicle;

FIG. 2 is a flowchart showing one example of the turning behavior stabilization control executed by the control system according to the present disclosure;

FIG. 3 is a nomographic diagram showing changes in rotational speeds of the rotary elements of the planetary gear set and a direction of the motor torque during execution of the routine shown in FIG. 2 to suppress excessive understeering during turning;

FIG. 4 is a nomographic diagram showing changes in rotational speeds of the rotary elements of the planetary gear set and a direction of the motor torque during execution of the routine shown in FIG. 2 to suppress excessive oversteering during turning;

FIG. 5 is a flowchart showing an example of the speed difference reduction control executed by the control system according to the present disclosure;

FIG. 6 is a nomographic diagram showing changes in rotational speeds of the rotary elements of the planetary gear set and a direction of the motor torque during execution of the routine shown in FIG. 5 to reduce the difference in rotational speeds between the front wheels and the rear wheels when the rotational speed of the rear wheels is significantly higher than the rotational speed of the front wheels; and

FIG. 7 is a nomographic diagram showing changes in rotational speeds of the rotary elements of the planetary gear set and a direction of the motor torque during execution of the routine shown in FIG. 5 to reduce the difference in rotational speeds between the front wheels and the rear wheels when the rotational speed of the front wheels is significantly higher than the rotational speed of the rear wheels.

### DETAILED DESCRIPTION OF THE PREFERRED EMBODIMENT(S)

Embodiments of the present disclosure will now be explained with reference to the accompanying drawings. It is to be noted that the embodiments described below are merely examples of the present disclosure, which should not limit the present disclosure.

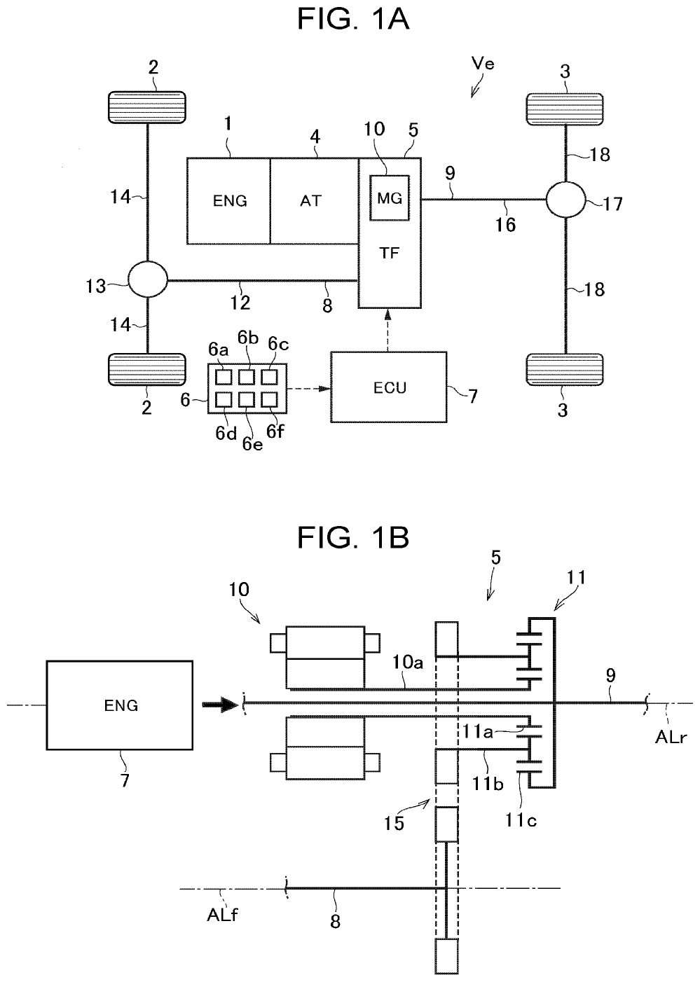

A control system according to the exemplary embodiment of the present disclosure is applied to a four-wheel drive layout vehicle in which a drive torque generated by a main prime mover is distributed to a pair of front wheels and a pair of rear wheels, and a drive force is established by both of the front wheels and the rear wheels. The four-wheel drive vehicle is provided with a transfer for distributing the drive torque to the front wheels and the rear wheels. The transfer comprises a differential mechanism in which three rotary elements are rotated differentially to one another, and a motor connected to one of the rotary elements of the differential mechanism. The transfer controls an output torque of the motor to change a split ratio between the torque transmitted to the front wheels and the torque transmitted to the rear wheels. The four-wheel drive vehicle to which the control device according to the embodiment of the present disclosure is applied further comprises at least an internal combustion engine or a motor serving as a main prime mover. In addition, the motor of the transfer described above may also serves as a prime mover. Therefore, given that the engine is adopted as the main prime mover, the four-wheel drive vehicle serves as a hybrid vehicle using the engine and the motor as the main prime mover. Otherwise, given that another motor is employed as the main prime mover, the vehicle serves as an electric vehicle using a plurality of motors as the prime mover. Turning now to FIGS. 1A and 1B, there is shown one example of a vehicle Ve to which the control system according to the exemplary embodiment of the present disclosure is applied.

In the vehicle Ve shown in 1A, an engine (ENG) 1 is employed as a main prime mover. That is, the vehicle Ve is a four-wheel drive vehicle in which the drive torque generated by the engine 1 is distributed to a pair of front wheels 2 and a pair of rear wheels 3 to establish a drive force. The vehicle Ve comprises an automatic transmission (referred to as AT in FIG. 1A) 4 that transmits the drive torque, a transfer (referred to as TF in FIG. 1A) 5, a detector 6, and a controller 7.

The engine 1 is an internal combustion engine that generates power by burning fuel, and for example, a gasoline engine, a diesel engine, or the like may be employed as the engine 1. The output power of the engine 1 is electrically controlled, and the engine 1 is electrically started and stopped. Note that the main prime mover of the vehicle Ve to which the control system according to the exemplary embodiment of the present disclosure is applied is not limited to the engine 1. For example, a motor that generates a drive torque may also be adopted as a main prime mover of the vehicle Ve. Otherwise, a hybrid drive unit including an engine and a motor may also be adopted as a main prime mover of the vehicle Ve.

In order to change a rotational speed of the engine 1 and to transmit the drive torque generated by the engine 1 to the transfer 5, the automatic transmission 4 is connected to an output shaft (not shown) of the engine 1 through a torque converter (not shown).

The drive torque is distributed to the front wheels 2 and the rear wheels 3 through the transfer 5. For this purpose, the transfer 5 is adapted to change a split ratio of the torque distributed to the front wheel 2 and the rear wheel 3. Specifically, as shown in FIG. 1B, the transfer 5 comprises a planetary gear set 11, a front output shaft 8, a rear output shaft 9, and a motor (referred to as MG in FIG. 1A) 10.

The planetary gear set 11 serving as a differential mechanism is a power transmission unit in which three rotary elements such as a first rotary element, a second rotary element, and a third rotary element are rotated differentially to one another. In the example shown in FIG. 1B, a single-pinion planetary gear set is adopted as the planetary gear set 11.

Specifically, the planetary gear set 11 comprises a sun gear 11a serving as the first rotary element, a carrier 11b serving as the second rotary element, and a ring gear 11c serving as the third rotary element. The sun gear 11a is connected to a rotary shaft 10a of the motor 10 in a torque transmittable manner, the carrier 11b is connected to a front output shaft 8 in a torque transmittable manner, and the ring gear 11c is connected to a rear output shaft 9 joined to an output shaft of the engine 1 in a torque transmittable manner.

The front output shaft 8 is a rotary shaft that delivers the torque to the front wheels 2. To this end, one end (in the left side of FIG. 1A) of the front output shaft 8 is joined to the front drive shaft 12, and the front drive shaft 12 is connected to the front wheels 2 through a differential gear unit 13 and drive shafts 14. The other end (in the right side of FIG. 1B) of the front output shaft 8 is joined to the carrier 11b of the planetary gear set 11 through e.g., a chain transmission mechanism 15. In the vehicle Ve, the front output shaft 8 is disposed along a rotational axis ALf that is different from a rotational axis of the rear output shaft 9.

The rear output shaft 9 is a rotary shaft that delivers the torque to the rear wheels 3. To this end, one end of the rear output shaft 9 (in the right side of FIG. 1A) is joined to the rear drive shaft 16, and the rear drive shaft 16 is connected to the rear wheels 3 through a differential gear unit 17 and the drive shafts 18. The other end (in the left side of FIG. 1B) of the rear output shaft 9 is connected to the ring gear 11c of the planetary gear set 11 and the output shaft of the engine 1. In the vehicle Ve, the rear output shaft 9 is arranged coaxially with the engine 1 and the planetary gear set 11 along the common rotational axis ALr.

The motor 10 is disposed coaxially with the engine 1 and the planetary gear set 11 on the common rotational axis ALr, and the motor 10 generates a motor torque that is different from the drive torque generated by the engine 1. Specifically, a rotary shaft 10a of the motor 10 is connected to the sun gear 11a of the planetary gear set 11. The motor 10 serves as an electric motor to generate a torque when driven by an electric power supplied thereto, and serves as a generator to generate an electric power when driven by an external torque applied thereto. That is, the motor 10 is a motor generator having a power generation function. For example, a permanent magnet synchronous motor, an induction motor, or the like may be employed as the motor 10. As shown in FIG. 1B, the motor 10 is arranged inside a housing (not shown) of the transfer 5 together with the planetary gear set 11, the front output shaft 8, and the rear output shaft 9. Otherwise, the motor 10 may also be arranged outside the housing of the transfer 5 separately from the planetary gear set 11, the front output shaft 8, and the rear output shaft 9.

The drive torque of the engine 1 delivered to the ring gear 11cof the planetary gear set 11 is distributed to the front output shaft 8 and the rear output shaft 9 through the transfer 5. That is, the transfer 5 serves as a power split device. In addition, the transfer 5 is adapted to change a condition of the differential rotation among the rotary elements of the planetary gear set 11 by controlling the torque of the motor 10 transmitted to the sun gear 11a of the planetary gear set 11. That is, the transfer 5 is adapted to control the split ratio of the torque distributed to the front output shaft 8 and the rear output shaft 9 by controlling the torque of the motor 10. In the exemplary embodiment of the present disclosure, an operating mode in which the split ratio of the torque distributed to the front output shaft 8 and the rear output shaft 9 is thus controlled by the torque of the motor 10 is referred to as a power split mode.

The detector 6 detects various kinds of data required to control the vehicle Ve. According to the exemplary embodiment of the present disclosure, the detector 6 comprises: a wheel speed sensor 6a that detects rotational speeds of the front wheels 2 and the rear wheels 3; a speed sensor 6bthat detects rotational speeds of the motor 10, the front output shaft 8, and the rear output shaft 9; a steering angle sensor 6c that detects a steering angle of the vehicle Ve; an acceleration sensor 6d that detects an acceleration of the vehicle Ve; a yaw rate sensor 6e that detects a yaw rate of the vehicle Ve; and a mode selector switch 6f that selects the operating mode of the vehicle Ve. The detector 6 is electrically connected to the after-mentioned controller 7, and transmits detection data in the form of an electric signal to the controller 7 based on a detection value or a calculated value of the above-mentioned sensors and devices.

The controller 7 is, for example, an electronic control unit comprising a microcomputer. According to the exemplary embodiment of the present disclosure, the controller 7 controls the split ratio of the torque distributed to the front output shaft 8 and the rear output shaft 9 by controlling the torque of the motor 10 connected to the transfer 5. For this purpose, various kinds of data detected or calculated by the detector 6 are sent to the controller 7, and the controller 7 performs a calculation using the input data, data stored in advance, a calculation formula, and so on. A calculation result is transmitted from the controller 7 in the form of command signal to control the torque of the motor 10 in the above-explained manner. Although FIG. 1A shows an example in which one controller 7 is provided, a plurality of controllers 7 maybe provided for each device to be controlled or for each control content to be executed.

The configuration (or gear train) of the vehicle Ve according to the exemplary embodiment of the present disclosure is not limited to that shown in FIGS. 1A and 1B. For example, the control system according to the embodiment of the present disclosure may also be applied to the hybrid vehicle described in the above-described U.S. Publication No. 2012/0077633 or the vehicle described in the above-described JP-A-05-278490 having the above-explained transfer 5. Further, a double-pinion planetary gear set or another type of planetary gear set may also be employed as the planetary gear set 11 of the transfer 5.

According to one aspect of the present disclosure, the control system is configured to perform a drive force distribution control in a power split mode. Specifically, the drive force distribution control is executed to control the torque of the motor 10 so as to adjust the split ratio of the torque distributed to the front output shaft 8 and the rear output shaft 9 to a predetermined target ratio by the planetary gear set 11 of the transfer 5. The target ratio may be set arbitrarily in accordance with a traveling condition of the vehicle Ve, and in response to an operation executed by the driver.

In addition, the control system is further configured to perform a turning behavior stabilization control in the event of understeering or oversteering greater than a reference value during turning of the vehicle Ve in the power split mode. Specifically, the turning behavior stabilization control is temporarily executed instead of the drive force distribution control to allow the motor 10 to generate a large torque momentarily for the purpose of suppressing the excessive understeering or oversteering.

According to another aspect of the present disclosure, the control system is further configured to execute the drive force distribution control in the power split mode, and execute the speed difference reduction control when the speed difference between the front wheels 2 and the rear wheels 3, that is, the speed difference between the front output shaft 8 and the rear output shaft 9 is greater than the reference value. Specifically, the speed difference reduction control is temporarily executed instead of the drive force distribution control to allow the motor 10 to generate a large motor torque for a moment thereby reducing the above-mentioned speed difference.

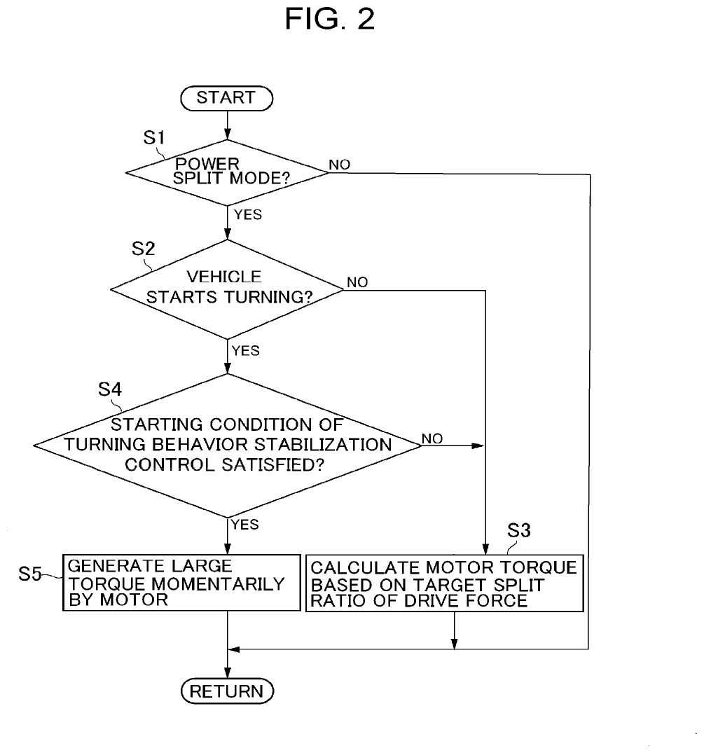

FIG. 2 is a flowchart showing one example of a routine according to the present disclosure to execute the drive force distribution control and the turning behavior stabilization control in the power split mode.

At step S1 in the routine shown in FIG. 2, it is determined whether or not the vehicle Ve is propelled in the power split mode. For example, the power split mode is selected manually by operating a selector switch (not shown) of the operating mode by the driver. Instead, the power split mode may also be selected by default. In this case, the power split mode may be cancelled by operating the selector switch. Otherwise, the power split mode may also be automatically selected according to the driving condition of the vehicle Ve.

If the vehicle Ve is not propelled in the power split mode so that the answer of step S1 is NO, the routine returns.

By contrast, if the vehicle Ve is propelled in the power split mode so that the answer of step S1 is YES, the routine progresses to step S2 to determine whether or not the vehicle Ve starts turning.

For example. such determination at step S2 may be made based on a detection value of the steering angle sensor 6c, an operating condition of a steering device (not shown) and the like.

If the vehicle Ve has not yet started turning so that the answer of step S2 is NO, the routine progresses to step S3 to execute the drive force distribution control.

As described above, during execution of the drive force distribution control, the torque of the motor 10 is controlled based on the predetermined target split ratio. Thereafter, the routine returns.

By contrast, if the vehicle Ve has already started turning so that the answer of step S2 is YES, the routine progresses to step S4 to determine whether or not a condition to start the turning behavior stabilization control is satisfied.

Specifically, the turning behavior stabilization control is executed when an understeering or an oversteering greater than a predetermined reference value occurs during turning of the vehicle Ve. Otherwise, the turning behavior stabilization control is executed when an occurrence of understeering or oversteering greater than the reference value is predicted during turning of the vehicle Ve.

The occurrence of understeering or oversteering of the vehicle Ve may be determined based on a steering angle and detection values of the acceleration sensor 6d and the yaw rate sensor 6e. For example, the occurrence of understeering is determined if a sideslip angle of the gravity center of the vehicle Ve calculated based on the detection values of the acceleration sensor 6d and the yaw rate sensor 6e are less than the steering angle. Conversely, the occurrence of oversteering is determined if the sideslip angle of the gravity center is greater than the steering angle. In addition, the occurrence of understeering may also be determined if the rotational speed of the front output shaft 8 is higher than the rotational speed of the rear output shaft 9. By contrast, the occurrence of oversteering may also be determined if the rotational speed of the rear output shaft 9 is higher than the rotational speed of the front output shaft 8. Otherwise, the occurrence of understeering or oversteering may be predicted based on the behavior and driving conditions of the vehicle Ve. For example, the occurrence of understeering is predicted if a speed of the vehicle Ve is higher than the reference speed, if a steering angle is larger than a reference angle, or if a friction coefficient of a road surface on which the vehicle Ve travels is lower than a reference coefficient. In addition, the occurrence of understeering may also be predicted if the vehicle Ve travels on a rough road where a road surface is uneven, a sandy road, a muddy road, or a snowy road. Further, the occurrence of understeering may also be predicted if a cant (i.e., a bank angle) of the road surface on which the vehicle Ve travels is a reverse cant (i.e., a reverse bank angle) with respect to a turning direction.

If the condition to start the turning behavior stabilization control is not satisfied so that the answer of step S4 is NO, the routine also progresses to step S3. In this case, although the vehicle Ve is turning, the vehicle Ve is neither understeering nor oversteering excessively and hence the behavior of the vehicle Ve is not disturbed. Therefore, the turning behavior stabilization control is not executed, but the drive force distribution control is executed as in the normal condition.

By contrast, if the condition to start the turning behavior stabilization control is satisfied so that the answer of step S4 is YES, the routine progresses to step S5 to execute the turning behavior stabilization control.

The turning behavior stabilization control includes an understeering suppressing control and an oversteering suppressing control, and the turning behavior stabilization control is executed to suppress excessive understeering or oversteering occurs or predicted during turning of the vehicle Ve.

As described above, the turning behavior stabilization control is commenced when an understeering or an oversteering larger than the reference value occurs during turning of the vehicle Ve, or when the occurrence of such understeering or oversteering is predicted based on the behavior and the traveling condition of the vehicle Ve. In addition, the turning behavior stabilization control may also be executed when the operating mode suitable to travel on a rough road or a snowy road is selected by manually operating the selector switch. Thus, the turning behavior stabilization control is executed when the above-explained starting condition is satisfied immediately after the vehicle Ve starts turning. As an option, when the vehicle Ve drives in a closed circuit in e.g., a sports mode or a circuit mode, the turning behavior stabilization control may also be executed every time the vehicle Ve makes a turn.

As described above, the turning behavior stabilization control is temporarily executed instead of the drive force distribution control so as to allow the motor 10 to generate a large torque for a moment. In the normal situation, the motor 10 generates a torque within a range less than an upper limit torque governed by the rated output. Nonetheless, it is still possible to generate a torque greater than the upper limit torque by the motor 10 within an extremely short period of time that is determined in advance based on the results of experiments or simulations. For example, when the sport mode is selected, a torque larger than that in the normal mode will be generated by the motor 10. Otherwise, a torque greater than the range of the normal drive force split ratio (0:100 to 100:0) may also be generated by the motor 10. Thereafter, the routine returns.

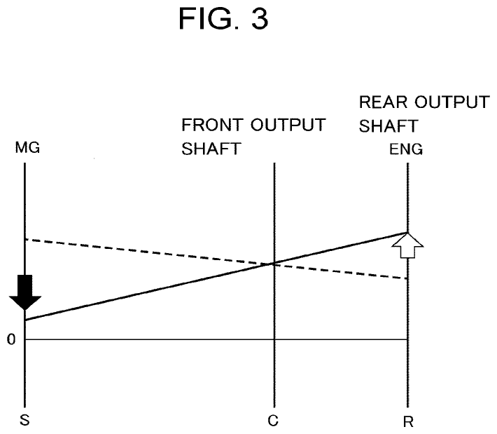

FIG. 3 is a nomographic diagram of the planetary gear set 11 showing the behavior of Ve during execution of the turning behavior stabilization control. In FIG. 3, the rotational speed of the sun gear 11a connected to the motor 10 is indicated on the vertical axis represented by “S”, the rotational speed of the carrier 11b connected to the front output shaft 8 is indicated on the vertical axis represented by “C”, and the rotational speed of the ring gear 11c connected to the engine 1 through the rear output shaft 9 is indicated on the vertical axis represented by “R”. In FIG. 3, the broken line indicates the condition of the planetary gear set 11 in the case that the vehicle Ve is understeering excessively. In the case that the vehicle Ve is understeering as indicated by the broken line, the front wheels 2 are rotated at a speed higher than the rotational speed of the rear wheels 3, and hence the carrier 11b is rotated at a speed higher than the rotational speed of the ring gear 11c. In order to suppress such an excessive understeering, the turning behavior stabilization control is executed to allow the motor 10 to temporarily generate a large torque so that the vehicle Ve is brought into oversteering as indicated by the solid line in the nomographic diagram shown in FIG. 3. Specifically, as indicated by the black arrow in the nomographic diagram shown in FIG. 3, the motor 10 generates a torque for a moment in a direction to reduce the rotational speed of the sun gear 11a. As a consequence, the excessive understeering during turning can be suppressed so that the behavior of the vehicle Ve is stabilized.

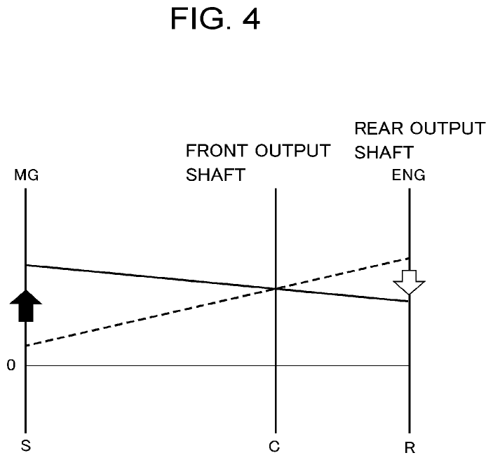

In the nomographic diagram shown in FIG. 4, the broken line indicates the situation where the vehicle Ve is oversteering excessively. When the vehicle Ve is oversteering as indicated by the broken line, the rear wheels 3 are rotated at a speed higher than the rotational speed of the front wheels 2, and hence the ring gear 11c is rotated at a speed higher than the rotational speed of the carrier 11b . In order to suppress such an excessive oversteering, the turning behavior stabilization control is executed to allow the motor 10 to temporarily generate a large torque so that the vehicle Ve is brought into understeering as indicated by the solid line in the nomographic diagram shown in FIG. 4.

Specifically, as indicated by the black arrow in the nomographic diagram shown in FIG. 4, the motor 10 generates a torque for a moment in a direction to increase the rotational speed of the sun gear 11a. As a consequence, the excessive oversteering during turning can be suppressed so that the behavior of the vehicle Ve is stabilized.

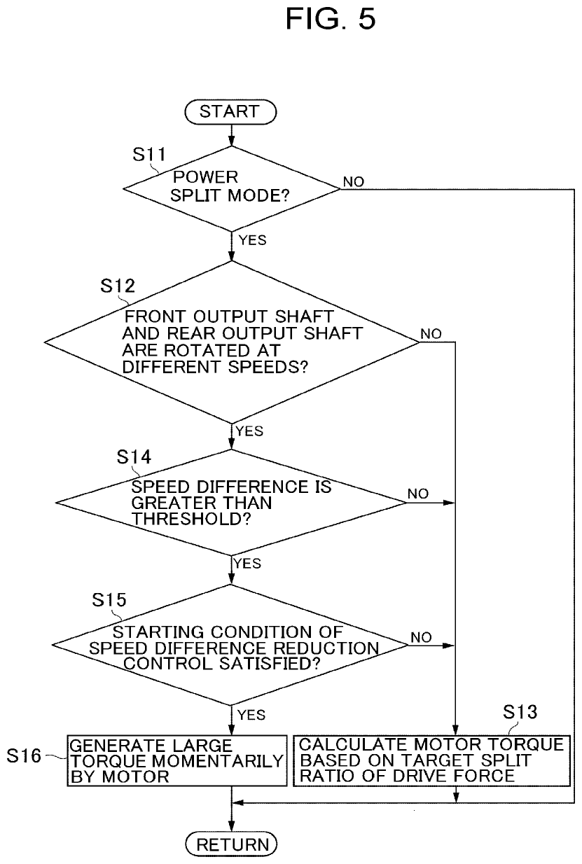

FIG. 5 is a flowchart showing another example of the routine according to the present disclosure to execute the drive force distribution control and the speed difference reduction control in the power split mode.

At step S11, it is determined whether or not the vehicle Ve is propelled in the power split mode. For example, the power split mode is selected manually by operating the selector switch (not shown) of the operating mode by the driver. Instead, the power split mode may also be selected by default. In this case, the power split mode may be cancelled by operating the selector switch. Otherwise, the power split mode may also be automatically selected according to the driving condition of the vehicle Ve.

If the vehicle Ve is not propelled in the power split mode so that the answer of step S11 is NO, the routine returns.

By contrast, if the vehicle Ve is propelled in the power split mode so that the answer of step S11 is YES, the routine progresses to step S12 to determine whether or not the front wheels 2 and the rear wheels 3 are rotated at different speeds.

At step S12, specifically, it is determined whether or not the front output shaft 8 and the rear output shaft 9 are rotated at different speeds. For example. such determination at step S12 may be made based on a detection value of the wheel speed sensor 6a and the speed sensor 6b.

If the front output shaft 8 and the rear output shaft 9 has not yet rotated at different speeds so that the answer of step S12 is NO, the routine progresses to step S13 to execute the drive force distribution control.

As described above, during execution of the drive force distribution control at step S13, the torque of the motor 10 is controlled based on the predetermined target split ratio. Thereafter, the routine returns.

By contrast, if the front output shaft 8 and the rear output shaft 9 are rotated at different speeds so that the answer of step S12 is YES, the routine progresses to step S14 to determine whether the speed difference between the front output shaft 8 and the rear output shaft 9 is greater than a predetermined reference value.

Specifically, the reference value is a threshold value set to determine a speed difference which may disturb the behavior of the vehicle Ve. That is, when the speed difference between the front output shaft 8 and the rear output shaft 9 is larger than the reference value, it is estimated that the behavior of the vehicle Ve will be disturbed. For this purpose, the reference value is set on the basis of results of experiments and simulations.

If the speed difference between the front output shaft 8 and the rear output shaft 9 is equal to or less than the reference value so that the answer of step S14 is NO, the routine also progresses to step S13. In this case, although the front output shaft 8 and the rear output shaft 9 are rotated at different speeds, such speed difference is determined as not being excessive difference which may disturb the behavior of the vehicle Ve. Therefore, the turning behavior stabilization control is not executed, and the drive force distribution control is executed as in the normal condition.

By contrast, if the speed difference between the front output shaft 8 and the rear output shaft 9 is greater than the reference value so that the answer of step S14 is YES, the routine progresses to step S15 to determine whether or not to execute the speed difference reduction control.

That is, at step S15, it is determined whether or not the starting condition of the speed difference reduction control is satisfied. The speed difference reduction control is basically executed when the speed difference between the front output shaft 8 and the rear output shaft 9 exceeds the reference value. The reference value may be changed based on the behavior of the vehicle Ve and the driving condition. For example, when the vehicle Ve is in a condition in which the speed difference between the front output shaft 8 and the rear output shaft 9 is expected to be increased, the reference value may be decreased. As a result, the speed difference between the front output shaft 8 and the rear output shaft 9 is easily eliminated. For example, the reference value may be reduced with a reduction in the frictional coefficient of the road surface on which the vehicle Ve travels. Otherwise, the reference may also be reduced when the vehicle Ve travels on an uneven road, sandy ground, muddy road, snowy road, or the like. In addition, if the above-mentioned selector switch is arranged in the vehicle Ve, the reference value may also be reduced when the operating mode suitable to travel on the uneven road, the snowy road or the like is selected.

If the starting condition of the speed difference reduction control is not satisfied so that the answer of step S15 is NO, the routine also progresses to step S13. In this case, although the front output shaft 8 and the rear output shaft 9 are rotated at different speeds, such speed difference is determined as not being excessive difference which may disturb the behavior of the vehicle Ve and which requires to execute the speed difference reduction control. Therefore, the turning behavior stabilization control is not executed, and the drive force distribution control is executed as in the normal condition.

By contrast, if the starting condition of the speed difference reduction control is satisfied so that the answer of step S15 is YES, the routine progresses to step S16 to execute the speed difference reduction control.

As described above, the speed difference reduction control is executed to reduce the speed difference between the front output shaft 8 and the rear output shaft 9. The speed difference reduction control is temporarily executed instead of the drive force distribution control to allow the motor 10 to generate a large torque momentarily thereby reducing the above-mentioned speed difference. In the normal situation, the motor 10 generates a torque within a range less than the upper limit torque governed by the rated output. Nonetheless, it is still possible to generate a torque greater than the upper limit torque by the motor 10 within an extremely short period of time that is determined in advance based on the results of experiments or simulations. Thereafter, the routine returns.

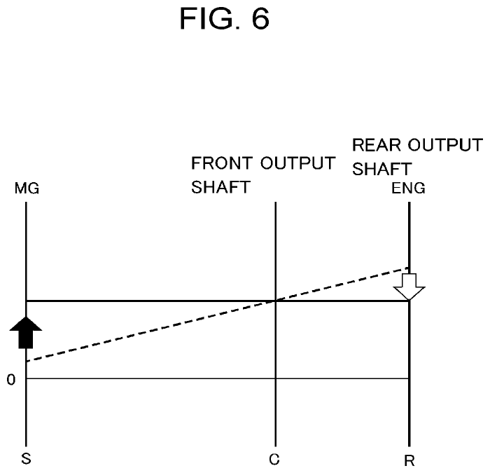

FIG. 6 is a nomographic diagram of the planetary gear set 11 showing the behavior of the vehicle Ve during execution of the speed difference reduction control. In FIG. 6, the rotational speed of the sun gear 11a connected to the motor 10 is indicated on the vertical axis represented by “S”, the rotational speed of the carrier 11b connected to the front output shaft 8 is indicated on the vertical axis represented by “C”, and the rotational speed of the ring gear 11cconnected to the engine 1 through the rear output shaft 9 is indicated on the vertical axis represented by “R”. In the nomographic diagram shown in FIG. 6, the broken line indicates the situation where the rear output shaft 9 is rotated at a speed significantly higher than the rotational speed of the front output shaft 8. In order to reduce such an excessive speed difference, the speed difference reduction control is executed to allow the motor 10 to temporarily generate a large torque so that the speed difference between the rear output shaft 9 and the front output shaft 8 is reduced to 0 as indicated by the solid line in the nomographic diagram shown in FIG. 6. Specifically, as indicated by the black arrow in the nomographic diagram shown in FIG. 6, the motor 10 generates a torque for a moment in the direction to increase the rotational speed of the sun gear 11a. As a result, the speed difference between the rear output shaft 9 and the front output shaft 8 can be reduced so that the behavior of the vehicle Ve is stabilized.

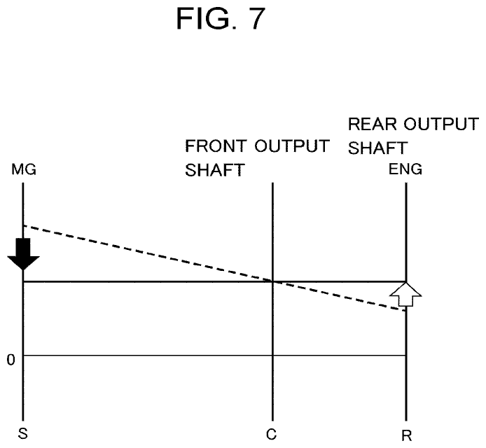

In the nomographic diagram shown in FIG. 7, the broken line indicates the situation where the front output shaft 8 is rotated at a speed significantly higher than the rotational speed of the rear output shaft 9. In order to reduce such an excessive speed difference, the speed difference reduction control is executed to allow the motor 10 to temporarily generate a large torque so that the speed difference between the front output shaft 8 and the rear output shaft 9 is reduced to 0 as indicated by the solid line in the nomographic diagram shown in FIG. 7. As indicated by the black arrow in the nomographic diagram shown in FIG. 7, the motor 10 generates a torque for a moment in the direction to reduce the rotational speed of the sun gear 11a. As a result, the speed difference between the front output shaft 8 and the rear output shaft 9 can be reduced so that the behavior of the vehicle Ve is stabilized.

Thus, the vehicle control system according to the exemplary embodiment of the present disclosure is configured to stabilize the behavior of the vehicle Ve by controlling the split ratio of the torque distributed to the front wheels 2 and the rear wheels 3 by the torque of the motor 10 connected to the transfer 5.

What is claimed is:

1. A control system for a vehicle comprising:
a main prime mover that generates a drive torque;
a motor that generates a torque different from the drive torque; and
a transfer that distributes the drive torque to front wheels and to rear wheels while changing a split ratio of the drive torque distributed to the front wheels and to the rear wheels;
wherein a drive force to propel the vehicle is established by both of the front wheels and the rear wheels,
the transfer comprises
a differential mechanism in which a first rotary element, a second rotary element, and a third rotary element are rotated differentially,
a front output shaft that delivers the torque to the front wheels, and
a rear output shaft that delivers the torque to the rear wheels,
the first rotary element is connected to the motor in a torque transmittable manner,
the second rotary element is connected to the front output shaft in a torque transmittable manner,
the third rotary element is connected to the main prime mover and the rear output shaft in a torque transmittable manner,
the control system comprises a controller that controls the motor,
the controller is configured to
execute a drive force distribution control to control the torque of the motor such that the split ratio of the drive torque is adjusted to a target ratio, and
execute a turning behavior stabilizing control temporarily instead of the drive force distribution control to increase the torque of the motor, when understeering or oversteering greater than a reference value is determined or predicted based on a behavior and a running condition of the vehicle while the vehicle is turning.

2. The control system for the vehicle as claimed in claim 1, wherein the turning behavior stabilizing control includes:
a control to increase the torque of the motor in a direction that a rotational speed of the rear output shaft is increased to a rotational speed of the front output shaft or higher, based on determination or prediction of the understeering; and
a control to increase the torque of the motor in a direction that the rotational speed of the front output shaft is increased to the rotational speed of the rear output shaft or higher, based on determination or prediction of the oversteering.

3. A control system for a vehicle comprising:
a main prime mover that generates a drive torque;
a motor that generates a torque different from the drive torque; and
a transfer that distributes the drive torque to front wheels and to rear wheels while changing a split ratio of the drive torque distributed to the front wheels and to the rear wheels;
wherein a drive force to propel the vehicle is established by both of the front wheels and the rear wheels,
the transfer comprises
a differential mechanism in which a first rotary element, a second rotary element, and a third rotary element are rotated differentially, a front output shaft that delivers the torque to the front wheels, and
a rear output shaft that delivers the torque to the rear wheels,
the first rotary element is connected to the motor in a torque transmittable manner,
the second rotary element is connected to the front output shaft in a torque transmittable manner,
the third rotary element is connected to the main prime mover and the rear output shaft in a torque transmittable manner,
the control system comprises a controller that controls the motor,
the controller is configured to
execute a drive force distribution control to control the torque of the motor such that the split ratio of the drive torque is adjusted to a target ratio, and execute a speed difference reduction control temporarily instead of the drive force distribution control to increase the torque of the motor, when a difference between a rotational speed of the front output shaft and a rotational speed of the rear output shaft is greater than a reference value.

4. The control system for the vehicle as claimed in claim 3, wherein the speed difference reduction control includes:
a control to increase the torque of the motor in a direction that the rotational speed of the rear output shaft is increased to the rotational speed of the front output shaft or higher, when the rotational speed of the front output shaft is higher than the rotational speed of the rear output shaft; and
a control to increase the torque of the motor in a direction that the rotational speed of the front output shaft is increased to the rotational speed of the rear output shaft or higher, when the rotational speed of the rear output shaft is higher than the rotational speed of the front output shaft.

5. The control system for the vehicle as claimed in claim 1,
wherein the differential mechanism includes a planetary gear set comprising a sun gear serving as the first rotary element, a carrier serving as the second rotary element, and a ring gear serving as the third rotary element,
the rear output shaft extends coaxially with a common rotational center axis of the main prime mover and the planetary gear set, and
the front output shaft extends along an axis different from the rotational center axis of the rear output shaft.

6. The control system for the vehicle as claimed in claim 2,
wherein the differential mechanism includes a planetary gear set comprising a sun gear serving as the first rotary element, a carrier serving as the second rotary element, and a ring gear serving as the third rotary element,
the rear output shaft extends coaxially with a common rotational center axis of the main prime mover and the planetary gear set, and
the front output shaft extends along an axis different from the rotational center axis of the rear output shaft.

7. The control system for the vehicle as claimed in claim 3,
wherein the differential mechanism includes a planetary gear set comprising a sun gear serving as the first rotary element, a carrier serving as the second rotary element, and a ring gear serving as the third rotary element,
the rear output shaft extends coaxially with a common rotational center axis of the main prime mover and the planetary gear set, and
the front output shaft extends along an axis different from the rotational center axis of the rear output shaft.

8. The control system for the vehicle as claimed in claim 4,
wherein the differential mechanism includes a planetary gear set comprising a sun gear serving as the first rotary element, a carrier serving as the second rotary element, and a ring gear serving as the third rotary element,
the rear output shaft extends coaxially with a common rotational center axis of the main prime mover and the planetary gear set, and
the front output shaft extends along an axis different from the rotational center axis of the rear output shaft.
